(19) United States
(12) Patent Application Publication
(10) Pub. No.: US 2008/0118779 A1
(43) Pub. Date: May 22, 2008

(54) Thin-film forming method, thin-film forming apparatus, and multilayer film

(75) Inventor: Kenji Noma, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,875

(22) Filed: Aug. 28, 2007

(30) Foreign Application Priority Data
Nov. 20, 2006 (JP) 2006-312692

(51) Int. Cl. G11B 5/64; C25B 9/00; C25D 17/00

(52) U.S. Cl. 428/826; 204/192.12; 204/298.11

(57) ABSTRACT

A thin-film forming method and a thin-film forming apparatus can suppress the oxidization of a magnetic layer composed of a non-oxide material when a film of oxide is formed on the magnetic layer by sputtering that is suited to mass production. A multilayer film with a low RA value can be produced by such method and apparatus. A thin-film forming method that forms a thin film of oxide on the surface of a substrate by dispersing the oxide inside a chamber includes an enclosing step of enclosing the substrate in the chamber and an adsorbing step of adsorbing excess oxygen present inside the chamber by providing an adsorption unit, which adsorbs oxygen, inside the chamber.

### TECHNICAL FIELD

The present art relates to a thin-film forming method, a thin-film forming apparatus, and a multilayer film, and in more detail to a thin-film forming method and a thin-film forming apparatus that form a thin film of oxide on the surface of a substrate by dispersing an oxide in a chamber, and to a multilayer film formed by such apparatus and method.

### BACKGROUND

It was announced in 2004 that an extremely high magnetoresistance of 100 to 200% had been achieved for a tunneling magnetoresistance (TMR) film that uses a barrier layer of magnesium oxide (MgO). Ever since then, this construction has been seen as the most promising technology for raising the reproduction output of a magnetic head used in a hard disk drive.

However, to use this kind of film (i.e., an MgO-TMR film) as a magnetic head, the resistance (i.e., RA value) across the surface of the MgO-TMR film needs to be 3Ωμm² or below. Attempts have been made to achieve a low RA value by controlling the thickness of the MgO layer to an order of 0.1 nm, but when the MgO layer is accumulated by sputtering which is suited to mass production, there has been the problem that excess oxygen atoms (O) ejected from the target oxidize the surface of the magnetic layer positioned below the MgO layer, thereby raising the RA value. Accordingly, there has been the problem of how to remove the excess oxygen during sputtering.

### SUMMARY

According to an aspect of an embodiment an apparatus comprises:

an enclosing step enclosing the substrate in the chamber; and

an adsorbing step adsorbing excess oxygen present inside the chamber by providing an adsorption unit, which adsorbs oxygen, inside the chamber.

### BRIEF DESCRIPTION OF THE DRAWINGS

The aforementioned and other objects and advantages of the present art will become apparent to those skilled in the art upon reading and understanding the following detailed description with reference to the accompanying drawings.

In the drawings:

FIG. 1 is a schematic diagram showing one example of a thin-film forming apparatus;

FIG. 2 is a schematic diagram useful in explaining a thin-film forming method;

FIG. 3 is a schematic diagram showing one example of a conventional semiconductor manufacturing apparatus;

FIG. 4 is a schematic diagram showing one example of a conventional sputtering apparatus; and

FIG. 5 is a schematic diagram useful in explaining how atoms behave when sputtering is carried out by the apparatus shown in FIG. 4.

### DETAILED DESCRIPTION OF THE EMBODIMENT

One example of a method of manufacturing a semiconductor device can reduce the amount of gaseous impurity particles such as O₂ during sputtering. This method is carried out by the manufacturing apparatus 100 shown in FIG. 3. A high-frequency voltage is applied to the electrodes 109 and 110 inside the sputtering chamber 101 to cause Ar discharge and produce plasma. After discharge starts, sputtering is carried out according to a condition whereby the ions in the plasma are prevented from colliding with an Al alloy target 103, so that only the surface of a target made of a getter material that easily adsorbs gas particles is used as sputter. This sputtering causes impurities such as O₂ and N₂ that remain in the sputtering chamber 101 to be adsorbed by the getter, resulting in a significant drop in the concentration of such impurities. When doing so, the atoms of the target 102 that have been converted into sputter are blocked by a shutter 106 inserted between the wafer 104 and the target 102 and therefore do not reach the wafer 104, resulting in no film being formed on the wafer 104. After the concentration of impurities such as O₂ and N₂ remaining in the sputtering chamber 101 has been sufficiently reduced, the shutter 106 is moved and then sputtering is carried out according to a changed condition whereby the surface of the getter material target 102 is not used as sputter, so that only the surface of the Al alloy target 103 is used as sputter.

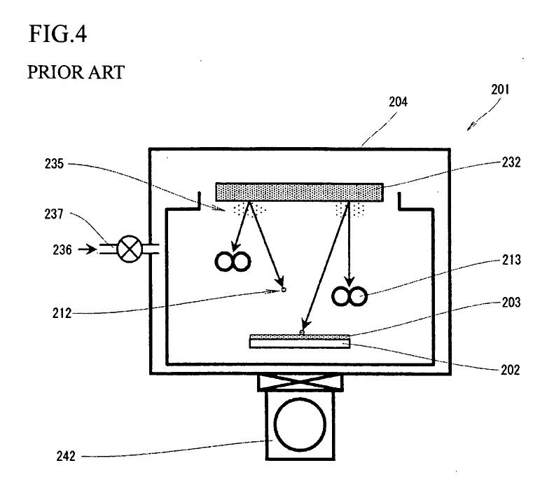

A thin film 203 of MgO is formed on a substrate by a typical sputtering apparatus 201 illustrated in FIG. 4

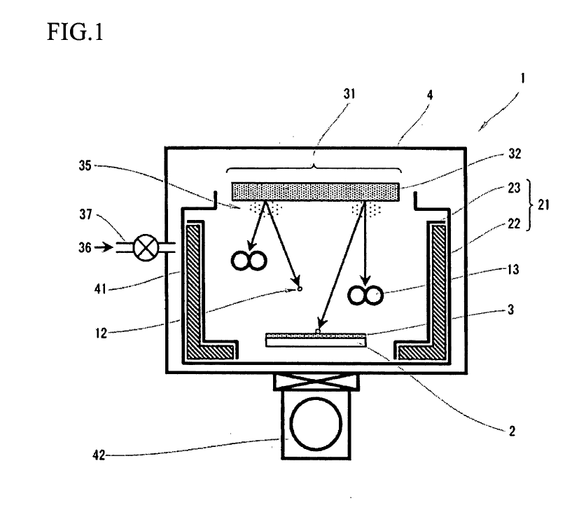

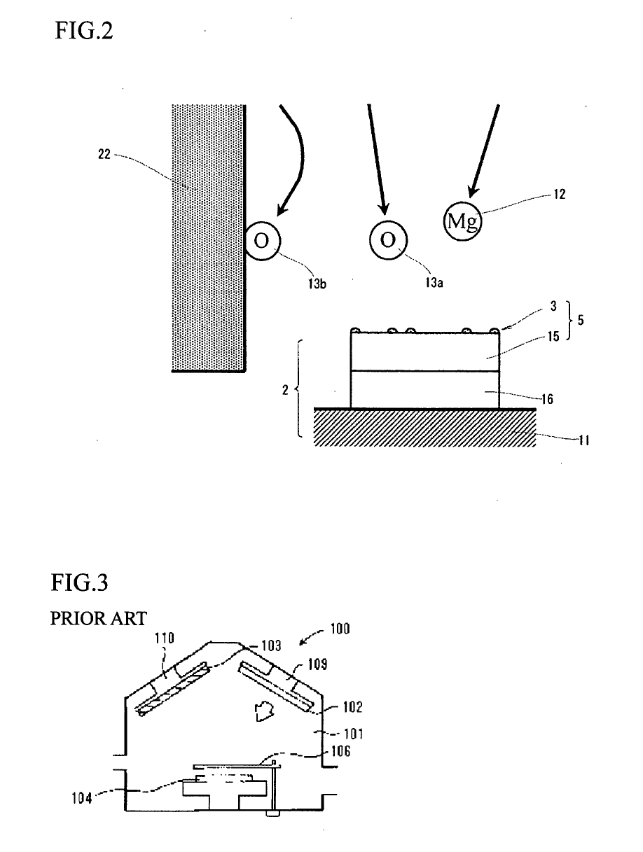

FIG. 1 is a schematic diagram showing one example of a thin-film forming apparatus 1 according to the present embodiment. FIG. 2 is a schematic diagram useful in explaining a thin-film forming method.

Note that reference numerals have been assigned in the drawings so that the numeral 13 is used for both reference numerals 13a and 13b (the same also applies to other numerals).

The thin-film forming apparatus 1 shown in FIG. 1 forms a thin film 3 of oxide on the surface of a substrate 2.

In the thin-film forming apparatus 1, an adsorption unit 21 and a dispersing unit 31 are provided in a chamber 4 that can be sealed. A vacuum pump 42 that can expel air to create a high vacuum of around 10⁻⁶ Pa inside the chamber 4 is connected to the chamber 4. A sputter gas supplying unit 37 that can supply sputter gas 36 into the chamber 4 is provided inside the chamber 4. The substrate 2 is provided so as to be capable of being placed inside and removed from the chamber 4. The substrate 2 is a semiconductor substrate, for example.

As shown in FIG. 1, the dispersing unit 31 includes a target material 32. The target material 32 is provided so as to be capable of being placed inside and removed from the chamber 4. When the thin-film forming apparatus 1 is used, the target material 32 is fixed to an inner wall of the chamber 4 using a fixture (not shown) and is constructed so that a DC or a high-frequency voltage can be applied thereto. Here, the target material 32 is an oxide, for example, and in the present embodiment, an example is described where magnesium oxide (MgO) is used.

As another embodiment of the target material 32, it is possible to use a material that does not contain oxygen, such as magnesium (Mg).

As shown in FIG. 1, the adsorption unit 21 includes a material (hereinafter referred to as the “adsorber”) 22 that adsorbs oxygen. The adsorber 22 should favorably be constructed so as to be fixed to an inner wall of the chamber 4 using a fixture (not shown). Here, examples of the adsorber 22 are a simple substance, an alloy, or a compound that has titanium (Ti), tantalum (Ta), ruthenium (Ru), rhodium (Rh), palladium (Pd), iridium (Ir), or platinum (Pt) as a principal constituent. There are no particular limitations on the shape of the adsorber 22, which may be formed in a bar shape or a plate shape, and to increase the surface area for adsorbing oxygen, the adsorber 22 may be produced in a mesh-like and/or porous form. The adsorber 22 may be produced using just the material listed above, or may be produced by forming a coating of such material on the surface of a base (not shown). As one example, the adsorption unit 21 is disposed so as to cover a periphery of the substrate 2 and an inner wall surface of a protective plate 41.

The adsorption unit 21 should preferably be equipped with a shield 23. In such case, the shield 23 should favorably cover the adsorber 22 so that the adsorber 22 cannot be seen when looking at the adsorption unit 21 from the target material 32. At a minimum, the shield 23 needs to be provided so that part of the surface of the adsorber 22 that faces the target material 32 is covered. Note that the surface of the adsorber 22 that does not face the target material 32 may be uncovered. Although there are no limitations on the material of the shield 23, it is favorable to use a material that does not adsorb oxygen. Note that as another embodiment, it is possible to use a construction where the adsorber 22 is provided on the rear surface of the shield 23.

Next, the procedure of the thin-film forming method according to the present embodiment realized using the thin-film forming apparatus 1 will be described.

First, the substrate 2 and the target material 32 are placed and fixed inside the chamber 4. After this, the chamber 4 is sealed and the vacuum pump 42 is driven to expel air until a high vacuum of around 10⁻⁶ Pa is reached inside the chamber 4. After the expelling of air, around 0.01 to 10 Pa of sputtering gas 36 is supplied inside the chamber 4 from the sputter gas supplying unit 37. In this state, a DC or high-frequency voltage is applied to the target material 32 to produce plasma 35. This plasma 35 collides with the target material 32. The sputter atoms 33 ejected from the target material 32 by the plasma adhere to the surface of the substrate 2 to form the thin film 3. Note that during sputtering, a protective plate 41 should preferably be provided inside the chamber 4 to prevent contamination occurring due to sputter atoms (magnesium ions in the present example) 12 adhering to the inner walls of the chamber 4 and then falling off. As examples, the protective plate 41 can be formed of stainless steel or aluminum alloy.

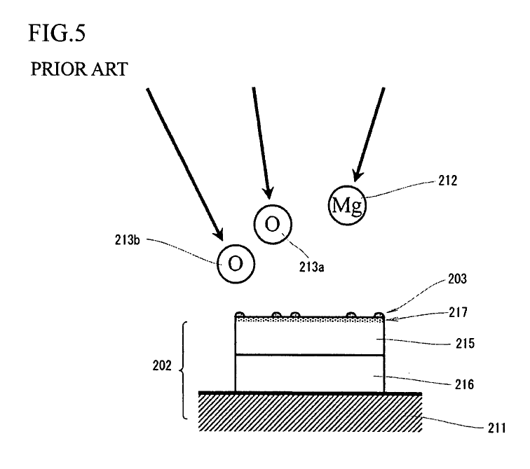

If a thin film is formed on the surface of a substrate by sputtering and the target material 32 is composed of magnesium oxide (MgO), the thin film 3 that accumulates on the surface of the substrate 2 will also be composed of magnesium oxide (MgO). In more detail, the atoms behave as follows during sputtering. As shown in FIG. 2, when magnesium (Mg) atoms 12 and oxygen (O) atoms 13 are ejected from the target material 32 by sputtering, the atoms will become temporarily dissociated and reach the surface of the substrate 2 separately, and then the atoms will recombine to form magnesium oxide (MgO), thereby forming the thin film 3 (in this example, an MgO film). Here, since some of the magnesium (Mg) atoms 12 adhere to the protective plate 41 or return to the target material 32 and therefore do not reach the substrate 2, an excess of oxygen (O) atoms 13 is produced. Some of the excess oxygen (O) atoms 13b are expelled by the vacuum pump 42, but if a non-oxidized film surface is present on the substrate 2, the oxygen (O) atoms 13b will oxidize such surface. For example, as shown in FIG. 5, when a magnetic layer 215 that composes the surface of the substrate 2 is made of cobalt-iron (CoFe), an oxide layer (in this example, a CoFeO layer) 217 will be formed on the magnetic layer 215.

With the present embodiment, the oxygen (O) atoms 13 are selectively adsorbed by the adsorption unit 21 provided inside the chamber 4. The shield 23 is provided so that the adsorber 22 cannot be seen when the adsorption unit 21 is viewed from the target material 32 and therefore suppresses the adsorption of magnesium (Mg) atoms 12 on the adsorber 22.

When the formation of the thin film 3 by sputtering is completed, the supplying of sputter gas 36 is stopped and air is expelled until the pressure inside the chamber 4 again reaches a vacuum of around 10⁻⁵ Pa. When doing so, if the material described above, that is, a simple substance, an alloy, or a compound that has titanium (Ti), tantalum (Ta), ruthenium (Ru), rhodium (Rh), palladium (Pd), iridium (Ir), or platinum (Pt) as a principal constituent is used for the adsorber 22, the dissociation pressure for oxygen (O) atoms will be high, and therefore the oxygen (O) atoms 13b adsorbed by the surface of the adsorber 22 during sputtering will become dissociated from the adsorber 22 and will be expelled by the vacuum pump 42. To promote dissociation in the high vacuum described above, it is effective to heat the adsorber 22 to an appropriate temperature.

By using the thin-film forming method described above, it is possible to form a multilayer structure 5 including the thin film 3 composed of oxide on the surface of the substrate 2 using the oxide dispersed inside the chamber 4. As examples, the multilayer structure 5 can be a magnetoresistance film, which is used for reading in a magnetic recording apparatus, or a magnetic recording medium.

By providing the adsorption unit 21 inside the chamber 4 and carrying out an adsorption step using the adsorption unit 21, it is possible to selectively adsorb the excess oxygen (O) atoms 13 ejected from the target material 32 during sputtering. As a result, since the excess oxygen (O) atoms 13b produced during sputtering are adsorbed by the adsorber 22 and therefore do not reach the surface of the substrate 2 during accumulation, it is possible to suppress the progressive oxidization of the magnetic layer (in this example, the CoFe layer) that constructs the surface of the substrate 2. Also, even for another embodiment where sputtering is carried out with a target material 32 composed of magnesium (Mg) and oxygen (O₂) as the sputter gas 36, by providing the adsorption unit 21 in the same way as described above, it is possible to reduce the amount of excess oxygen (O) atoms and therefore excessive oxidization of the surface of the substrate 2 can be prevented.

Here, if the shield 23 were not provided in the adsorption unit 21, the magnesium (Mg) atoms 12 ejected from the target material 32 would adhere to the surface of the adsorber 22. If, as a result, the amount of magnesium (Mg) atoms 12 adhering to the surface of the adsorber 22 were to increase due to the formation process of the thin film 3 being repeatedly carried out, it would become no longer possible to adsorb the excess oxygen (O) atoms 13, i.e., the adsorber 22 would fail to achieve the purpose for which it is provided. For this reason, by providing the shield 23, it is possible to suppress adsorption of the magnesium (Mg) atoms 12 ejected from the target material 32 during sputtering on the surface of the adsorber 22 which would accumulate as a magnesium (Mg) film. Note that even when the shield 23 is provided, the oxygen (O) atoms 13 differ to the magnesium (Mg) atoms 12 in that the atoms 13 can move behind the shield 23 and reach the adsorber 22. This means that adsorption (and dissociation) of the oxygen (O) atoms 13 by the adsorber 22 can occur without any problems.

Also, as described earlier, the adsorber 22 has a comparatively high physical bonding force with oxygen (O) and an effect whereby adsorbed oxygen (O) becomes easily dissociated at high temperature or low pressure. That is, the adsorber 22 is formed so that the oxygen (O) atoms 13 adsorbed on its surface can be easily dissociated compared to the iron (Fe), chromium (Cr), nickel (Ni), aluminum (Al) or the like used for the inner walls of the chamber 4 and the protective plate 41, and therefore it is possible to eject the adsorbed oxygen (O) atoms 13 by producing a high vacuum of 10⁻⁵ Pa or below inside the chamber 4 after sputtering. As a result, the next time a film is formed by sputtering, it is possible to use the adsorber 22 in a state where no oxygen (O) atoms 13 have been adsorbed on the surface of the adsorber 22, which means that the adsorption performance can be maintained. Accordingly, it is possible for the adsorber 22 to repeatedly adsorb the excess oxygen (O) atoms 13 without the adsorber 22 having to be replaced. Note that although it is possible to use an organic material with a property whereby the oxygen (O) atoms 13 can be adsorbed and dissociated as the adsorber 22, in view of the degassing of the chamber 4, it is favorable to use the material described earlier (i.e., a simple substance, an alloy, or a compound that has titanium (Ti), tantalum (Ta), ruthenium (Ru), rhodium (Rh), palladium (Pd), iridium (Ir), or platinum (Pt) as a principal constituent).

Since the multilayer structure 5 is formed via the adsorption step described earlier, oxidization of the surface of the magnetic layer (the CoFe layer in this example) 15 positioned below the thin film (the MgO film in this example) 3 by the excess oxygen (O) atoms 13 ejected from the target material 32 is suppressed. As a result, it is possible to form the thin film (the MgO film in this example) 3 with a thickness controlled to an order of 0.1 nm. By doing so, it is possible to suppress the RA value of the multilayer structure 5 (i.e., RA<3Ωμm²). Accordingly, it is possible to use the multilayer structure 5 as a tunneling magnetoresistance film that uses magnetic oxide (MgO) as a barrier layer in the magnetic head of a hard disk drive and to increase the reproduction output of the magnetic head by doing so.

As described above, according to the present embodiment, even when a film of an oxide is formed on a magnetic layer 15 composed of a non-oxide material by sputtering which is suited to mass production, it is possible to suppress the oxidization of the magnetic layer 15. In particular, when the formed multilayer structure 5 is a tunneling magnetoresistance film, it is possible to suppress unnecessary oxidization of the magnetic layer 15 when accumulating the thin film 3 that forms the barrier layer. This means it is possible to realize a low RA value, and as a result, it is possible to achieve high tunneling magnetoresistance.

What is claimed is:

1. A thin-film forming method of forming a thin film of oxide on a surface of a substrate by dispersing the oxide inside a chamber, comprising:
an enclosing step enclosing the substrate in the chamber; and
an adsorbing step adsorbing excess oxygen present inside the chamber by providing an adsorption unit, which adsorbs oxygen, inside the chamber.

2. A thin-film forming method according to claim 1, further comprising, after the enclosing step, a dispersing step dispersing the oxide by sputtering a target material.

3. A thin-film forming method according to claim 2, wherein the target material does not contain oxygen.

4. A thin-film forming method according to claim 1, wherein the adsorption unit is composed of a material that includes at least one of titanium, tantalum, ruthenium, rhodium, palladium, iridium, and platinum.

5. A thin-film forming method according to claim 2, wherein at least part of a surface of the adsorption unit that faces the target material is covered by a shield.

6. A thin-film forming apparatus that forms a thin film of oxide on a substrate, comprising:
a chamber that encloses the substrate and the oxide; and
an adsorption unit adsorbing oxygen inside the chamber.

7. A thin-film forming apparatus according to claim 6, further comprising a dispersing unit dispersing the oxide by sputtering a target material.

8. A thin-film forming apparatus according to claim 6, wherein the adsorption unit is composed of a material that includes at least one of titanium, tantalum, ruthenium, rhodium, palladium, iridium, and platinum.

9. A thin-film forming apparatus according to claim 7, wherein at least part of a surface of the adsorption unit that faces the target material is covered by a shield.

10. A multilayer film where a thin film of oxide is formed on a surface of a substrate by oxide dispersed inside a chamber, wherein the multilayer film is formed by carrying out at least:
an enclosing step enclosing the substrate in the chamber; and
an adsorbing step adsorbing excess oxygen present inside the chamber by providing an adsorption unit, which adsorbs oxygen, inside the chamber.

11. A multilayer film according to claim 10, wherein the multilayer film is one of a magnetic recording medium and a magnetoresistance film that is used for reading in a magnetic recording apparatus.
